(19) United States
(12) Patent Application Publication
(10) Pub. No.: US 2003/0146323 A1
(43) Pub. Date: Aug. 7, 2003

(54) Flipping and pitching reel

(76) Inventor: George C. Jeane, Evans, LA (US)

Correspondence Address: William W. Stagg, Durio, McGoffin & Stagg, PC, P.O. Box 51308, Lafayette, LA, 70505, US

(21) Appl. No.: 10/068,695

(22) Filed: Feb. 5, 2002

(51) Int. Cl. A01K 89/015

(52) U.S. Cl. 242/310; 242/322

(57) ABSTRACT

A fishing reel comprising a frame having forward and rearward ends and two sides to which is mounted a transversely orientated, revolvable cylindrical spool. The spool has a recessed channel of a substantially rectangular cross-section for holding a length of coiled fishing line. A line guide is mounted on said frame in a fixed position forward of the spool for directing and positioning the fishing line onto the spool channel. The line guide is positioned on the frame in alignment with the centerline of the spool channel, the center of the line guide being no lower than the mid-point of the spool channel and no higher than the rim of the spool channel. The reel includes a mechanism for controlling the rotation of the spool for dispensing fishing line on to and off of the spool.

### FIELD OF INVENTION

The present invention generally relates to the field of fishing reels and more particularly relates to an improved fishing reel specifically designed for use of the flipping technique of casting a fishing lure.

### BACKGROUND OF INVENTION

When casting lures or baits with a rod, reel and line while fishing, especially while fishing for largemouth bass, it behooves the fisherman to utilize a number of different casting techniques to enhance the lure presentation so as to maximize the chances of catching fish. Included in such casting techniques are methods known as flipping and pitching the lure, also known as “flippin” and “pitchin”.

The flipping method is intended for accurate lure presentation to a desired location, usually visible, thick cover between 10 and 20 feet away from the fisherman. The technique typically calls for the use of a heavy action rod at least 6½ to 7½ feet in length. In flipping, a length of line approximately twice the length of the rod, with a lure attached at the end of the line, is let out from the line reel attached at the rod handle. The line is held by the fisherman's free hand with the free arm extended to allow approximately half the line, with the lure attached, to extend past the front tip of the rod. The rod tip is then raised to make the attached lure swing back close to the body of the fisherman and then lowered to make the lure swing forward. The fisherman then rolls the butt of the rod to the inside of the arm and, as the lure moves past the rod tip, line is released from the fisherman's free hand as the rod tip is raised. When the lure nears the target, the rod tip is lowered again to make the lure touch down softly at the target by stopping the lure before it enters the water.

The pitching method is intended for a very quiet lure entry on targets between 10 and 30 feet away from the fisherman and typically used for casting single-hook lures such as worms, jigs or spinnerbaits with rods in excess of 6½ feet. The pitching method of casting a lure begins with the fisherman facing the target. The fisherman then releases line with the lure attached until the lure is even with the reel. Then, with the lure held at waist level in the fisherman's free hand, the rod tip is lowered toward the water to put tension on the line. Then, with the tension on the line, the rod tip is swung forward toward the target with the fisherman's wrist in one smooth, quick, upward motion, as the fisherman lets go of the lure with the free hand. When the lure moves from beneath the rod tip, line is then released from the reel with the continuous elevation of the rod tip so as to “pitch” the lure just above the water. The fisherman, with a combination of line tension and rod movements, then guides the lure to the target. When properly “pitched” the lure will land softly in the water.

When using the aforementioned techniques with revolving spool reels such as bait casting reels, especially the pitching method, care must be taken in controlling the spool tension or the line on the reel will “backlash” or ‘bird’s nest” causing tangling of the fishing line on the reel. Using conventional bait casting reels having revolving spools and level wind mechanisms when employing flipping and pitching casting methods requires the fisherman to make precise settings of the reel's spool tension control as well as precise control of the revolution of the reel spool with the thumb to avoid backlash and tangling of the line on the reel spool. Learning such spool control is difficult, even for the most experienced fisherman, and the novice fisherman will typically need a great deal of practice before these techniques can be effectively utilized. Consequently, a need exist for an improved revolving spool bait casting reel that will facilitate the use of flipping and pitching casting techniques.

### SUMMARY OF INVENTION

The present invention provides a revolving spool bait casting type reel that can be utilized for casting a fishing lure attached to the end of a fishing line in the conventional overhand manner but is adapted to facilitate the use of the reel when the flipping and pitching casting techniques described above are employed by the user. The reel of Applicant's invention may include conventional drag and spool-braking systems common on revolving spool bait casting reels, but further incorporates a stationary, centrally situated, line guide on the reel to position the fishing line on a uniquely configured revolving line spool.

The line spool of Applicant's reel is shaped to center and store the fishing line on a centrally positioned line storage area of the reel spool. In Applicant's reel the line storage area is comprised of a line channel or groove formed as part of the revolving spool. The width of the line channel of the spool of Applicant's reel is narrow in relation to its depth so as to form a line-holding channel having a substantially rectangular cross-section for holding and distributing the line stored on the spool.

Applicant's reel has no level wind mechanism to layer the line onto the revolving spool. The line received and stored on the line-holding channel of the spool is distributed through a centrally positioned line guide so as to allow the line to be stacked within the line-holding channel as it is coiled onto the revolving spool. During a cast, line is distributed from the line-holding channel of the spool through the centrally positioned line guide.

It has been found that during the casting of a lure, the fishing line will distributed from the line-holding channel of the revolving spool in a more uniform manner and with less likelihood of line backlash or tangling of line when the line is guided on and off the revolving reel spool through a fixed, stationary, centrally positioned line guide. Casting is further improved when the width of the line guide is kept between ⅜ and ⅝ of the width of the line-holding channel of the revolving spool.

### BRIEF DESCRIPTION OF THE DRAWINGS

FIG. 1 is a perspective view of the fishing reel design of Applicant's invention.

FIG. 2 is a side view of the fishing reel design shown in FIG. 1.

FIG. 3 is a front elevation view of the fishing reel design shown on line 3-3 of FIG. 2.

FIG. 4 is an alternative front elevation view of the fishing reel design shown on line 4-4 of FIG. 2.

FIG. 5 is a cross-sectional view of the fishing reel design cut on line 5-5 of FIG. 2.

FIG. 6 is a cross-sectional view of the fishing reel design cut on line 6-6 of FIG. 3.

### DESCRIPTION OF EMBODIMENTS

Referring now to the drawings and more particularly to FIG. 1, there is shown a perspective view of the fishing reel (10) of Applicant's invention mounted on a conventional longitudinally extending casting rod (30). The reel (10) is comprised of a frame (11) having a line guide support (13), line guide (15) and revolving cylindrically shaped spool (20). The spool (20) has a line-holding channel (26) of a substantially rectangular cross-section formed in the center of the spool (20) for holding a length of coiled fishing line (28). The revolving spool (20) is positioned on the reel (10) so that when the reel (10) is mounted on the rod (30), the axis of rotation of the spool (20) is transverse to the longitudinally extending rod (30).

A spooling mechanism (16), having a conventional handle, spool drag, spool release and spool braking mechanisms, is used to control rotation of the spool (20). Fishing line (28) is coiled onto and distributed from the line-holding channel (26) of the spool (20) as the spool (20) revolves during the casting and reeling in of a fishing lure. The reel (10), as shown in FIG. 1, is depicted in a side elevation view in FIG. 2.

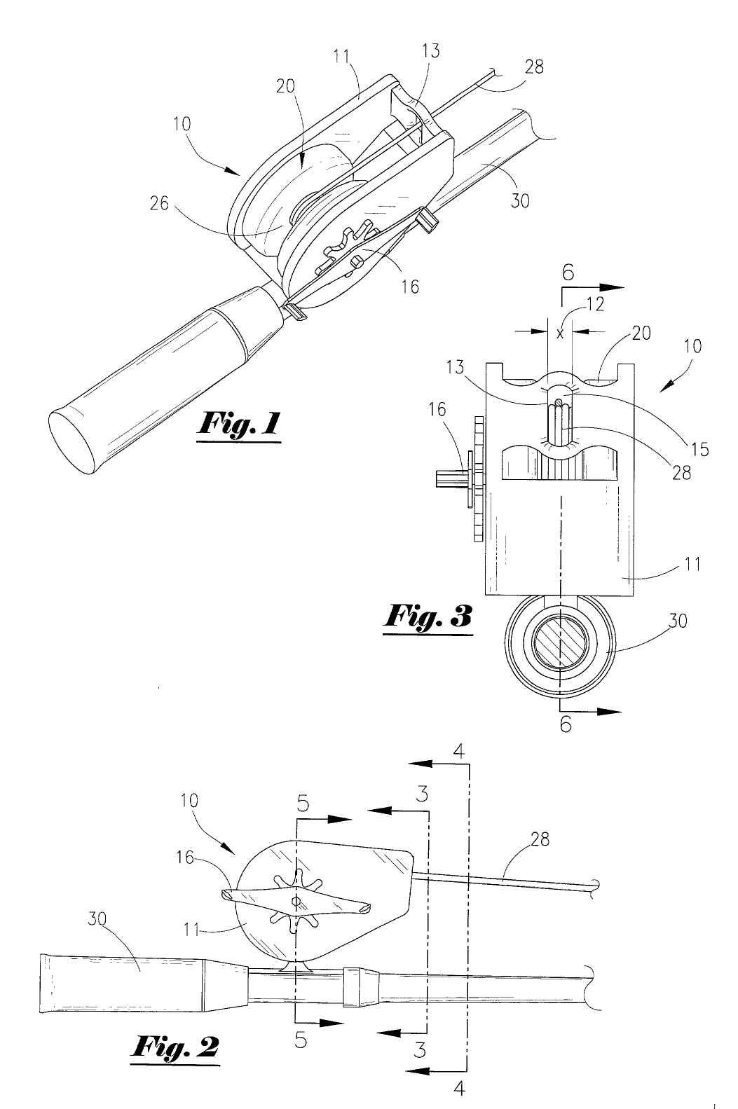

A front elevation view of the fishing reel (10) shown from line 3-3 of FIG. 2 is displayed in FIG. 3. The stationary line guide (15) is positioned on the line guide support (13) so as to place the line guide (15) in front of and in line with the middle of the line-holding channel (26) formed in the center of the spool (20). In FIG. 3, the line guide (15) is shown as a vertically extending elongated ring, the width of which is less than the width of the line-holding channel (26) and the length of which is less than the depth of the line-holding channel (26). It is thought that line tangling and backlash will be minimized when the vertical dimension of the line guide (15) is kept in the range of about ⅜ to about ⅝ of the depth of the line channel (26) and the width of the line guide (15) is kept in the range of about ⅜ to about ⅝ of the width of the line channel (26). It is also thought that the line will be distributed more readily from the line-holding channel (26) of the revolving spool (20) when the line guide (15) is positioned on the line guide support (13) so as to place its vertical mid-point no lower than approximately the vertical mid-point of the line-holding channel (26) and no higher than approximately the top rim of the line holding channel (26).

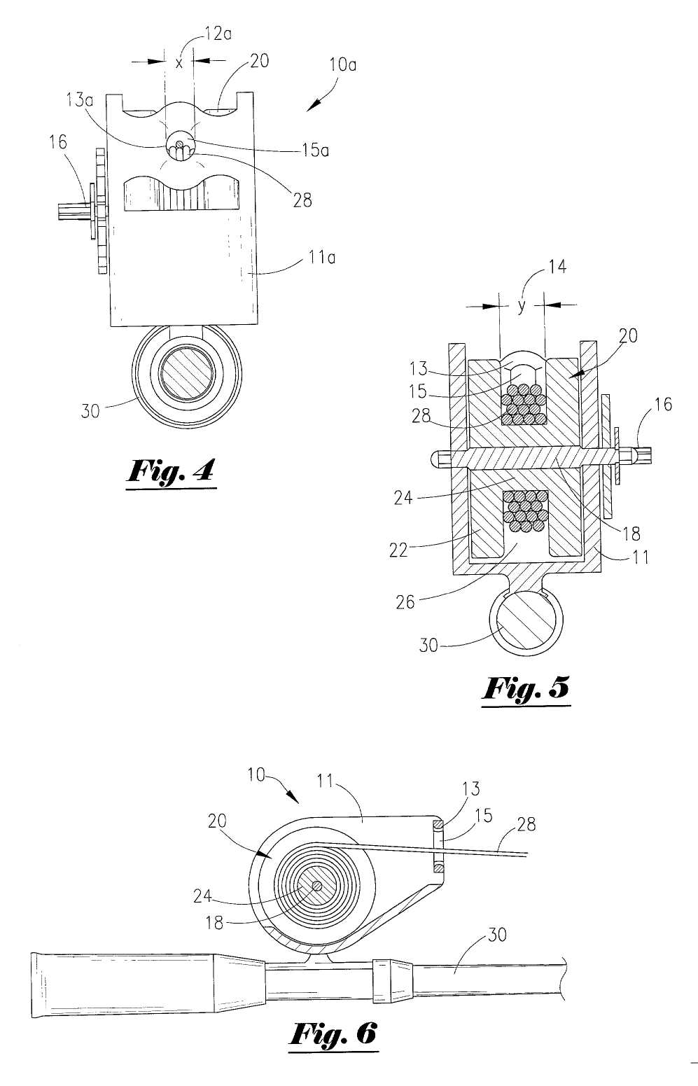

FIG. 4 is an alternative front elevation view of the fishing reel design shown on line 4-4 of FIG. 2. FIG. 4 illustrates an alternative embodiment of Applicant's fishing reel design designated as (10a) mounted on a casting rod (30). In the alternative embodiment, the reel (10a) has a circularly configured, stationary line guide (15a) positioned on line guide support (13a) of reel frame (11a) so as to center the line guide (15a) in front of and in line with the middle of the substantially rectangular line-holding channel (26) formed in the center of the spool (20). The circular line guide (15a) has a diameter X, designated as (12a), that is less than the width of the line-holding channel (26). It is thought that the keeping the diameter X of the line guide (15a) in the range of about ⅜ to about ⅝ of the width of the line channel (26) will be suitable for Applicant's reel and will minimize the incidence of backlash and line tangling while casting with the pitching and flipping methods described herein. Applicant has also found that when the diameter X, designated as (12a), of the line guide (15a) is approximately 3/16 inches and the width of the line channel (26) is approximately 11/32 inches, the incidence of line backlash and tangling during casting of a lure by the pitching and flipping methods described with a reel (10a) according to Applicant's invention will be further minimized.

FIG. 5 shows a cross-sectional view of the fishing reel (10a) cut on line 5-5 of FIG. 2. From this view, it can be seen that the spool (20) has a centrally positioned substantially rectangular shaped line-holding channel (26) for retaining a quantity of coiled fishing line. The spool (20) is supported by spool hub (24) that is attached to the transversely extending spool axel (18) that is rotably mounted on reel frame (11), the rotation of the spool (20) being controlled by the cranking mechanism (16). The line-holding channel (26) of the spool (20) is configured in a substantially rectangular cross-section so as to allow for the fishing line (28) stored around the line-holding channel (26) to be coiled and stacked as the spool (20) is revolved. The substantially rectangular configuration of the channel (26) allows the coiled fishing line (28) to be distributed from the spool (20) uniformly as the spool (20) revolves to discharge the line (28) during a cast.

The circular line guide (15) shown in FIG. 5 has a width Y, designated as (14), that is less than the width of the line-holding channel (26). It is thought that the keeping the width Y of the line guide (15) in the range of about ⅜ to about ⅝ of the width of the line channel (26) will be suitable for Applicant's reel and will be sufficient to reduce the incidence of line backlash and tangling commonly associated with employing pitching and flipping casting methods with revolving spool casting reels.

FIG. 6 is a cross-sectional view of the fishing reel (10) cut on line 6-6 of FIG. 3. This view illustrates the location of the guide (15) with respect to the spool (20). The guide (15) is positioned forward of and upward from the axel (18) of the spool (20) to guide the line (28) onto the line channel (26). Applicant has found that maintaining the mid-point of the guide (15) at a point no lower than approximately the vertical mid-point of the line-holding channel (26) and no higher than approximately the rim of the line-holding channel (26) will enhance performance of the reel (10) during casting.

It is thought that the fishing reel design of the present invention and many of its attendant features will be understood from the foregoing description. It is also thought that a variety of changes may be made in the form, construction and arrangement of the disclosed fishing reel design without departing from the spirit and scope of its invention.

I claim:

1. A fishing reel, comprising:
(a) a frame, said frame having forward and rearward ends and two sides;
(b) a transversely orientated, revolvable cylindrical spool mounted to said frame, said spool having a recessed channel for holding a length of coiled fishing line; and
(c) means for positioning said fishing line onto said channel of said spool; and
(d) means for controlling the rotation of said spool and thereby dispensing said fishing line on to and off of said spool.

2. The fishing reel according to claim 1 where in said means for positioning said fishing line onto said channel of said spool includes a line guide mounted on said frame in a fixed position forward of said spool.

3. The fishing reel according to claim 2 wherein, said recessed channel of said spool has a substantially rectangular cross-section.

4. The fishing reel according to claim 3 wherein, the mid-point of said line guide is positioned so as to be in alignment with the centerline of said recessed channel.

5. The fishing reel according to claim 4 wherein, said line guide is substantially circular.

6. The fishing reel according to claim 5 wherein, the diameter of said substantially circular line guide is in the range of about ⅜ to about ⅝ of the width of said channel.

7. The fishing reel according to claim 6 wherein, the center of said substantially circular line guide is positioned no lower than approximately the vertical mid-point of said channel and no higher than approximately the rim of said channel.

8. The fishing reel according to claim 4 wherein, said line guide is a vertically extending elongated ring.

9. The fishing reel according to claim 8, the width of said elongated ring line guide being in the range of about ⅜ to about ⅝ of the width of the said channel and the length of said elongated ring line guide being in the range of about ⅜ to about ⅝ of the depth of said channel.

10. The fishing reel according to claim 9 wherein, the mid-point of said elongated ring line guide is fixedly positioned no lower than approximately the vertical mid-point of said channel and no higher than approximately the rim of said channel.

11. The fishing reel according to claim 5 wherein, said line guide is approximately 3/16 inches in diameter and said line channel is approximately 11/32 inches in width.

12. The fishing reel according to claim 11 wherein, the center of said line guide is positioned no lower than approximately the vertical mid-point of said channel and no higher than approximately the rim of said channel.

13. A fishing reel, comprising:
(a) a frame, said frame having forward and rearward ends and two sides;
(b) a transversely orientated, revolvable cylindrical spool mounted to said frame, said spool having a recessed channel of a substantially rectangular cross-section for holding a length of coiled fishing line; and
(c) a circular line guide fixedly mounted on said frame forward of said spool for positioning said fishing line onto said channel of said spool, the center of said line guide positioned so as to be in alignment with the centerline of said recessed channel; and
(d) means for controlling the rotation of said spool and thereby dispensing said fishing line on to and off of said spool.

14. The fishing reel according to claim 13 wherein, the diameter of said line guide is in the range of about ⅜ to about ⅝ of the width of said channel.

15. The fishing reel according to claim 14 wherein, the center of said line guide is positioned no lower than approximately the vertical mid-point of said channel and no higher than approximately the rim of said channel.

16. The fishing reel according to claim 13 wherein, said line guide is approximately 3/16 inches in diameter and said line channel is approximately 11/32 inches in width.

17. The fishing reel according to claim 16 wherein, the center of said line guide is positioned no lower than approximately the vertical mid-point of said channel and no higher than approximately the rim of said channel.

18. A fishing reel, comprising:
(a) a frame, said frame having forward and rearward ends and two sides;
(b) a transversely orientated, revolvable cylindrical spool mounted to said frame, said spool having a recessed channel of a substantially rectangular cross-section for holding a length of coiled fishing line; and
(c) a line guide fixedly mounted on said frame forward of said spool for positioning said fishing line onto said channel of said spool, said line guide being configured as a vertically extending elongated ring, the center of said elongated ring positioned so as to be in alignment with the centerline of said recessed channel; and
(d) means for controlling the rotation of said spool and thereby dispensing said fishing line on to and off of said spool.

19. The fishing reel according to claim 18 wherein, the width of said elongated ring line guide being in the range of about ⅜ to about ⅝ of the width of the said channel and the length of said elongated ring line guide being in the range of about ⅜ to about ⅝ of the depth of said channel.

20. The fishing reel according to claim 19 wherein, the vertical mid-point of said elongated ring line guide is positioned no lower than approximately the vertical mid-point of said channel and no higher than approximately the rim of said channel.
